(19) United States
(12) Patent Application Publication
(10) Pub. No.: US 2006/0218408 A1
(43) Pub. Date: Sep. 28, 2006

(54) System and method for user authentication employing portable handheld electronic devices

(76) Inventor: Michael Lawrence Serpa, Oakland, CA (US)

Correspondence Address: KNOBBE MARTENS OLSON & BEAR LLP, 2040 MAIN STREET, FOURTEENTH FLOOR, IRVINE, CA, 92614, US

(21) Appl. No.: 11/086,143

(22) Filed: Mar. 22, 2005

(51) Int. Cl. G06F 12/14; H04L 9/00; G06F 17/30; H04K 1/00; G06F 12/00; G06F 13/00; G06F 7/04; G06F 7/58; G06K 19/00; G11C 7/00; H04L 9/32

(52) U.S. Cl. 713/183; 726/17

(57) ABSTRACT

A system and method for user authentication employing a portable handheld electronic device to store, in digital form, a user's password, access code, or PIN. The portable handheld electronic device can be any such device capable of visual output and/or auditory output, such as a mobile telephone, a personal music player, or a PDA. When the user receives a true visual cue and/or a true auditory cue from the portable handheld electronic device, an input command can be entered that will cause the password, access code, or PIN to be transmitted to gain access. In an alternative embodiment, the password, access code, or PIN is changed during each access granted session and stored in the portable handheld electronic device. A new security code is therefore used each time the user seeks access.

### FIELD OF THE INVENTION

This invention relates to security codes such as passwords, access codes, and Personal Identification Numbers, for authenticating users.

### BACKGROUND OF THE INVENTION

Passwords, access codes, Personal Identification Numbers (“PINs”) and the like have become a normal part of life for most individuals. In a time when electronic devices and digital technology seem to be everywhere, user authentication is a necessity. Cipher locks controlling access to a facility, financial transactions conducted via the internet, voice mailboxes, e-mail accounts, ATM machines/point-of-sale stations, etc., all require some form of password or code (and frequently a user identification string as well).

These codes are intended to ensure electronic security and are here to stay. Yet they only provide security if they remain a secret to everyone except the legitimate user. Making passwords and access codes longer and including in them a variety of numbers, letters, and symbols might make them more difficult to crack, but this also makes them harder to remember. And because we are forced to remember a variety of such codes/passwords, many of us simply write them down and leave the written record in a place were it can easily be found by an unauthorized intruder. Such practices obviously defeat the purpose of a security code.

Furthermore, we, as users of these electronic devices, age as time goes by. It might therefore very well be the case that it will become more and more difficult for us to remember these numbers and codes—and use all of these devices and systems—due to loss of memory problems associated with old age. If younger users already are finding it difficult to cope with a large quantity of random (but essential) information in the form of passwords/access codes/PINs, then in the future the task of remembering these security features will become increasingly burdensome.

And an ageing user population is not the only reason why an improvement to the current system of security codes would be useful. Some neurologists believe that significant differences between the sexes could make some types of passwords/access codes easier or more difficult for the user to remember depending upon whether the user is male or female. For example, women are more likely to be “bilateral types,” using both sides of their brain more or less equally, while men tend to be “asymmetrical,” favoring either their verbal or scientific lobes. A system that mandates the length and components of passwords (i.e. “Passwords must be between 5 and 8 characters in length and must include numbers as well as letters”) does not leave much room for customization to the preferences and capabilities of individual users.

An alternative system and method for user authentication that eliminates the need to memorize a random string of characters, as is typical of most authentication processes employing passwords, but instead requires only the memory of user-selected visual and auditory cues, would be useful. The present invention offers such a system and method. It is intended to be extremely user friendly while still ensuring a strict level of electronic security.

### SUMMARY OF THE INVENTION

The system and method of the present invention works by employing portable handheld electronic devices to store users' actual passwords/access codes/PINs in order to relieve users of the burden of remembering theses security codes. When access is desired, the portable handheld electronic device is connected, by a suitable means, to the thing to be accessed (e.g., a device, system, program, file, database, etc.) Then, when the user receives true visual and/or true auditory cues from the portable handheld electronic device, the user inputs a command (by key press, touch screen contact, etc.) for the portable handheld electronic device to transmit the stored correct security code to gain access. Security is guaranteed because the true visual and/or auditory cues are known only to the user.

The portable handheld electronic device can be any such device that is capable of producing visual output, auditory output, or both. Therefore, any device that has a display and/or a speaker or speakers (or a headset, earphones, etc.) will work. Many such devices are in common use already, such as mobile phones, Personal Digital Assistants, and personal music players (although not all personal music players have displays). Personal Digital Assistants (often called “PDAs”) have displays, but not all have speakers.

The highest level of security will result when using devices that produce both auditory and visual output. This will become apparent from the discussion below.

Because it relies on electronic devices already carried by many individuals, the present invention is intended to be simple to use. It expands the purpose of these devices by utilizing them for an additional task: keeping track of the user's passwords, access codes, and PINs. All of these electronic devices have computer memory, so the present invention can be implemented through software instructions. Some devices and systems, however, might require hardware modifications for certain embodiments described herein.

The preferred embodiments can also be applied to a portable handheld electronic device specifically designed for, or dedicated to, the purpose/function of storing a user's security codes.

There are several keys to the security provided by the present invention. First, the actual password/access code/PIN can be very long and complicated because the user need not commit it to memory. In fact, it can be a completely random string programmed independent of the user. Second, the items the user must remember—a visual cue and and/or an auditory cue—are selected by the user and can be things she has little trouble remembering (such as a photo of a friend, her child's voice, a favorite song, a picture of a popular celebrity, a name in her phone's address book, etc.). Thus, the user has the ability to “customize” her authentication sequence according to her individual preferences. And third, the visual and auditory output of many of the portable handheld electronic devices discussed above cannot be easily intercepted by someone other than the user (particularly in the case of auditory output). It would therefore be extremely difficult for an unauthorized intruder to determine which visual and/or auditory cues prompted the user to input the password or access code.

And if the portable handheld electronic device itself can be password protected, this would add an additional layer of security to the system and method of the present invention.

### BRIEF DESCRIPTION OF THE DRAWINGS

The above and other objects and features of the present invention will become apparent from the following description of preferred embodiments given in conjunction with the accompanying drawings, in which:

FIG. 1 shows a flow diagram for an authentication sequence that includes only a true auditory cue or only a true visual cue and where a user id is entered by separate means.

FIG. 2 shows a flow diagram for an authentication sequence that includes both a true auditory cue and a true visual cue and where a user id is entered by separate means.

FIG. 3 shows a flow diagram for an authentication sequence that includes both a true auditory cue and a true visual cue and where the user id, if necessary, can be automatically transmitted.

FIG. 4 shows a flow diagram for an authentication sequence wherein: (i) both a true auditory cue and a true visual cue are included; (ii) user id and user account information are automatically transmitted; and (iii) the password is changed for the next authentication sequence.

### DETAILED DESCRIPTION AND OPERATION OF THE PREFERRED EMBODIMENTS

The following discussion will begin with an explanation of implementing the system and method of the present invention with a personal music player. The discussion will then explain some of the differences relating to using a mobile telephone or PDA in place of the personal music player.

Currently the most popular personal music player on the market is the Apple iPod, though there are models offered by other manufactures as well. Personal music players have computer memory for storing musical content in digital form. Some of these devices have small hard drives to hold data while others rely on flash memory. Personal music players also have a means or means for connecting them to a computer that is, in turn, connected to the internet. These connections are used for downloading the musical content. Usually the personal music player to computer connection is made though a USB port, but other methods are available (e.g., Fire Wire). In the future these devices might have wireless transmission/reception capabilities.

In accordance with a preferred embodiment, a correct password is stored in the personal music player's computer memory. Again, as discussed above, the correct password (or a correct access code, correct PIN, or other correct security code) can be long and complicated, and completely random, as is suitable for a given application. There can also be stored one or more false passwords, the purpose of which will be discussed below. It should be understood, however, that the correct password—when transmitted—will by definition result in access granted. The system and method of the present invention simply authorizes or blocks transmission of the correct password.

Also stored in the personal music player's computer memory, in digital form, is a true auditory cue selected by the user and one or more false auditory cues. The software implementing this embodiment can provide a library of sounds for the user to select from for use as the true auditory cue and one or more false auditory cues, or the user can input other sounds from other sources for this purpose. If the personal music player has a display, the computer memory will preferably also contain a true visual cue and one or more false visual cues.

The true auditory cue and one or more false auditory cues can be any suitable sound, such as a bell ringing, a human voice saying a particular word, a motorcycle engine revving, a bird chirping, etc. The true auditory cue is associated with the correct password. The one or more false auditory cues are associated the one or more false passwords, or no password.

The true visual cue and the one or more false visual cues can be any suitable image capable of being show on the personal music player's display. The true visual cue is associated with the correct password, and the one or more false visual cues are associated with the one or more false passwords, or no passwords.

In the case of a personal music player, the true auditory cue can simply be a song the user has previously stored in the computer memory of the personal music player, and the true visual cue can be the title of another song already stored. The other songs stored, and their titles, will then serve as the one or more false auditory cues and the one or more false visual cues.

If a user identification name or number is required for a particular application, that string can be stored in the personal music player's computer memory as well, or the user can input the user id by separate means (such as by keyboard or keypad).

In this example, the correct password stored in the personal music player's computer memory is the password that will grant access to the user's account at a financial institution such as a bank or brokerage. The financial institution account and the software instructions implementing this embodiment, as contained in the personal music player, have previously agreed on the correct password (and a user id as well if that arrangement is desired). The correct password can be set by the software without the user's input, or it can be set by the user. It is not necessary for the user to know what the correct password is.

To access the account, the user will log on to the financial institution's website. When prompted to enter a user identification number and password, the user will connect the personal music player to the computer via the USB port or other suitable means.

The user then puts the personal music player's earphones in his ears (or the headphones on his head). Using a button on the personal music player, the user initiates an authentication sequence that can be either passive or active. In a passive authentication sequence, the one or more false auditory cues is/are randomly played by the personal music player as well as the true auditory cue. The one or more false auditory cues and the true auditory cue can each last for any duration of time, as determine suitable for the particular application or the preferences of the user (though longer time durations will necessarily lead to lengthier authentication sequences). When the true auditory cue is played, the user can execute a transmit command by pressing a button or switch on the personal music player, where upon the correct user id and password will be transmitted to the brokerage account website resulting in access granted. (Again, as stated above, the user can input the user id separately using a computer keyboard or other input device.) If the user instead presses the button when a false auditory cue is playing, transmission of the correct password will be blocked.

In an active authentication sequence, the user scrolls through the index of the personal music player to go directly to the true auditory cue and inputs a command to play the true auditory cue. This active authentication sequence can be faster than the passive authentication sequence because the user does not need to wait for the true auditory cue to play.

Because no one but the user can hear the true auditory cue and the one or more false auditory cues (he is the only one wearing the earphones to the personal music player), no one else can have any idea which was the true auditory cue. Thus, an unauthorized user who gets hold of the personal music player would have to guess which sound being played is right one. To reduce the danger posed by this type of attack, the software can be designed to allow only a limited number of guesses (after which the account is placed on hold pending an investigation).

Alternatively, a true visual cue could be used in place of the true auditory cue. When the true visual cue is displayed on the display of the personal music player, transmission of the security code is authorized.

In an embodiment that includes both the true auditory cue and the true visual cue, the user's button press (or other input command) initializing the password transmission must occur while the true auditory cue is playing and the true visual cue is displayed simultaneously. If the button is pressed when the true visual cues is displayed, but one of the one or more false auditory cues is playing (or if the true auditory cue is playing while one of the one or more false visual cues is displayed), access will be denied.

Alternatively, there could be multiple true auditory cues employed. In this embodiment, the correct password would only be transmitted if the user presses the transmit button or switch after hearing the true auditory cues in a correct sequence. This would result in an even more secure authentication process since the unauthorized user would have to guess a number of true auditory cues in a correct sequence. Similarly, there can be multiple true visual cues employed that must appear in a certain sequence or pattern before the correct password will transmit.

If included, the one or more false passwords stored in the computer memory could be useful to prevent an attack wherein an unauthorized intruder attempts to read the data stored in the computer memory. If there are many long false passwords stored, this intruder would have a difficult time with his attack because he would not know which was the correct password.

If the user has selected as his true auditory cue a song already stored in the computer memory, and, as his true visual cue, the name of another song already stored in the computer memory, the user would play the song serving as the true auditory cue. While the song is playing, he would then scroll through his song listing until the name of the song serving as the true visual cue appears, or appears highlighted, on the display. At this point, password transmission is authorized.

Due to the small size of the personal music player's display, it is difficult for someone other than the user to see which was the true visual cue. The identity of the true auditory cue is protected as well because only the user can hear the auditory output of the personal music player.

There are a number of options here for software designers, system engineers, and hardware manufacturers, and it might be the case that changes will be made to personal music players, as well as to internet-connected computers and financial institution websites and databases, to make implementation of the preferred embodiments more effective and user friendly.

Using the preferred embodiments with a mobile telephone is similar to the above discussion involving personal music players. However, in the case of mobile phones, current designs normally do not have a means for a hard wire connection to another device or system. Many, though, have the capability to transmit data wirelessly to a PDA or computer (using Bluetooth or other technologies). If a wireless transmission of a password or access code is deemed appropriate for a given application, then the present invention can be use with mobile telephones as well (since they all have visual displays and provide auditory output, and they all have computer memory). But because these wireless transmissions can be easily intercepted, encrypted passwords, access codes, and PINs might be preferred.

When the present invention is used with a mobile telephone, the true visual cue could be a name or telephone number already stored in the user's phone. If the phone user is not using a headset or ear jack, etc. while operating the phone, it is not possible to view the phone's display while listening to the auditory output because the phone must be held to the user's ear. In this situation, a true auditory cue or a true visual cue embodiment of the present invention—but not both in combination—could be suitable.

If the mobile phone is one of the so-called Third Generation (or “3G”) phones, the visual cue could be a video clip (or even a particular segment of a video clip) as opposed to a still image.

Alternatively, future versions of mobile phones might have the ability to transmit data to another device or system via a hard wire connection. This would facilitate an even more secure implementation of the present invention.

As is true for personal music players, the displays of most mobile phones are small and thus not easily seen by someone other than the user. This helps preserve the confidentiality of the user's true visual cue. And, unless the phone has a speakerphone feature that is activated, only the phone's user can hear the auditory output (and therefore the true auditory cue).

Many mobile telephones now included digital camera technology. This feature could facilitate the capture of images to serve as a true visual cue or a false visual cue.

The present invention is also well suited for use with PDAs. Many PDAs have the same wireless transmission capability that mobile phones have, and most can be hard wire connected to a computer via a USB port or other connection. Thus, a PDA can be used to apply the preferred embodiments anytime a password must be entered to gain access to a computer, a network, a facility, an ATM/point-of-sale station, or a website.

Again, if a password/access code/PIN is transmitted wirelessly, it could be encrypted.

If the PDA is configured to provide auditory output as well as visual output, then the embodiment described above combining a true visual cue with a true auditory cue can be used for providing maximum security. To help conceal the true auditory cue, a headset or earplugs (or the like) can be used.

Some PDAs permit a user to input commands using a pen-like item that, when touching icons on a PDA's display, executes desired functions. (For example, to open a user's date book, the user would touch the “Date Book” icon on the display.) These icons can serve to form the true visual cue. That is, to gain access, the user would manipulate the icons in a particular way—such as moving the icons around to form a certain pattern or “hiding” some icons but not others—to authorize the transmission of a correct password. The user would then reset the icons to the original pattern when the authentication sequence is ended and access has been granted.

Perhaps ATMs and point-of-sale stations in retail establishments might one day accept a user's PIN directly by wireless transmission using encrypted signals from the user's PDA or mobile telephone! Or ATMS/point-of-sale stations could include a port for a hard wire connection to a PDA, mobile telephone, or personal music player for PIN transmission in accordance with the preferred embodiments.

In the case of ATM machines and point-of-sale stations, the portable handheld electronic device could hold a user's account number and other information as well as the user's password, thus eliminating the need for the user to carry an ATM or debit card.

Other potential applications of the preferred embodiments are in the area of facility access controls. Instead of cipher locks with keypads for inputting an access code, the present invention could be employed to permit users to input the access code using their personal music player, their mobile telephone, or their PDA. Software designed for these situations could also include a capability for identifying each particular user by a unique code assigned to the user's handheld portable electronic device to keep a record of the dates and times of the user's arrivals and departures.

In a highly sophisticated preferred embodiment, the password, access code, or PIN is reset—that is, changed—at the end of every access granted session. This is possible because the innovation of the present invention is to store the passwords/access codes/PINs in the computer memory of portable handheld electronic devices instead of requiring users to the commit the security code to memory. This embodiment would work as follows: At some point before the end of a particular access granted session, a new password/access code/PIN would be agreed upon and stored in the computer memory to be used for the next authentication sequence. The new password/access code/PIN could be generated by either the software in the portable handheld electronic device or by software or a computer on the other end. A logoff command can then be sent and the session terminated.

This new password/access code/PIN would then be used the next time the user seeks access.

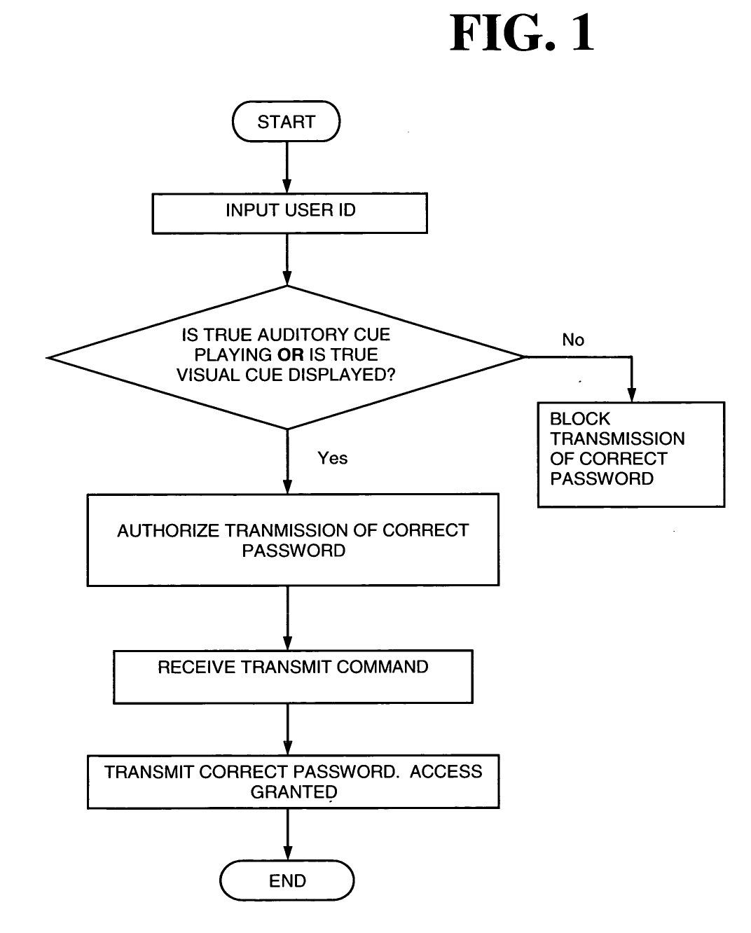

Referring now to the drawings, in FIG. 1 is shown a flow diagram in accordance with one preferred embodiment. In this embodiment, the user must first enter a user identification sting using a keyboard, keypad, electronic pen, etc. Next, the personal handheld electronic device must then display a true visual cue or play a true auditory cue which will authorize the transmission of the correct password. The user will then transmit the correct password by executing a transmit command by button press, key press, switch activation, etc. Access is then granted.

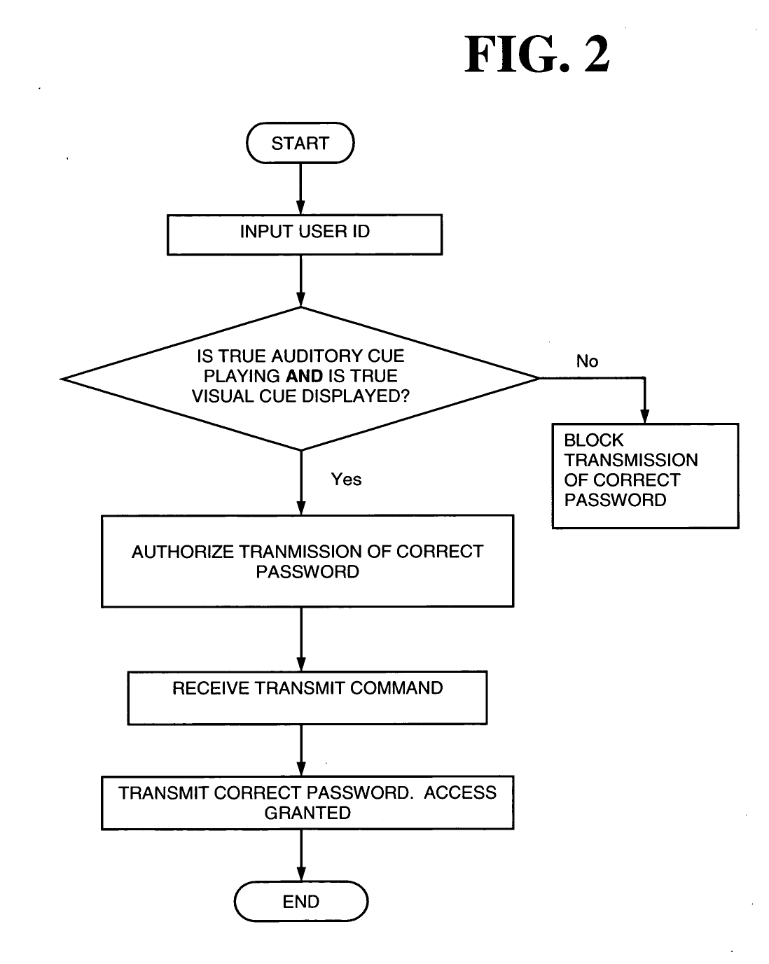

The authentication sequence illustrated by the flow diagram in FIG. 2 is similar to that illustrated by FIG. 1, except that both a true auditory cue and a true visual cue are included. The true visual cue must be displayed while the true auditory cue is playing in order for a successful true password transmit command to be executed.

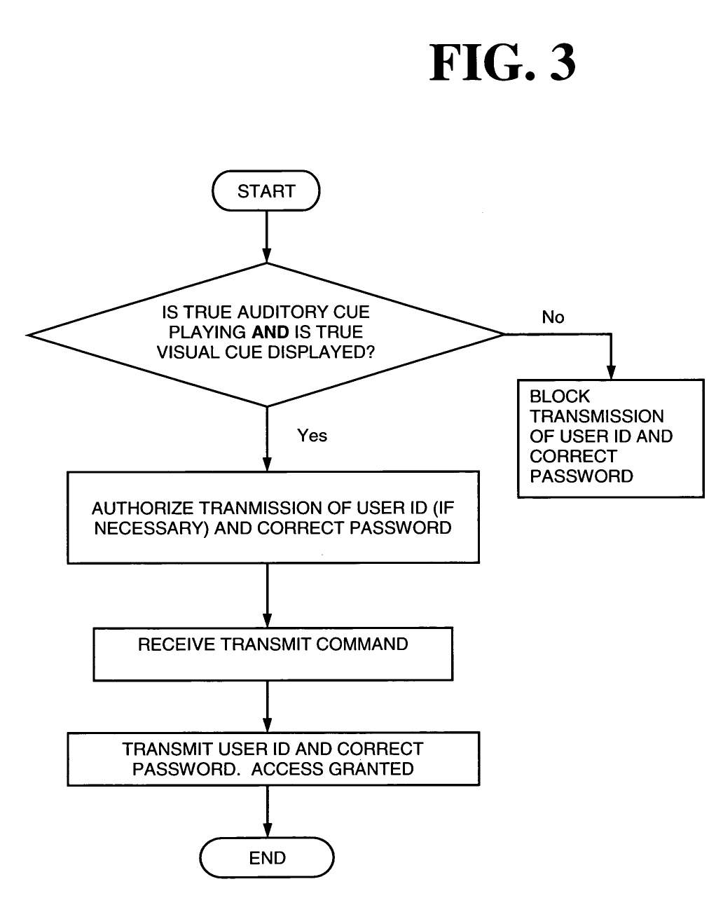

Illustrated in FIG. 3 is a flow diagram in accordance with another embodiment in which a user identification string and other user account information is stored along with the password (or access code or PIN) in the computer memory of the portable handheld electronic device. This eliminates the need for the user to memorize the user id and enter it by separate means.

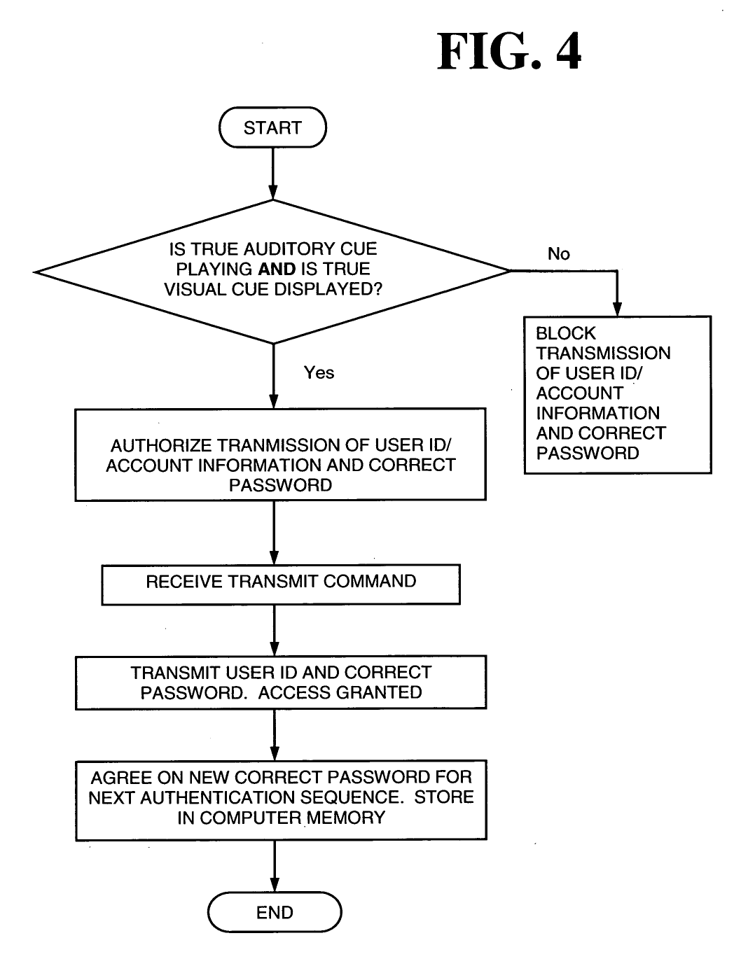

Shown in FIG. 4 is an authentication sequence that includes both a true visual cue and a true auditory cue and in which the user's account information along with the user identification string and the correct password are stored in the portable handheld electronic device. This would be an example of an authentication sequence for an ATM/point-of-sale transaction that does not require an ATM card or debit card. An additional feature of the sequence illustrated in FIG. 4 is that the correct password (or access code or PIN) is changed during the access granted session so a new security code will be used each time the user seeks access.

In accordance with the preferred embodiments, multiple user passwords, access codes, and PINs can be stored on a user's portable handheld electronic device. The true auditory cue and true visual cue can be the same for all stored security codes, or each security code can have its own unique true auditory cue and true visual cue. These determinations should be made depending on user preferences and particular electronic security needs.

Because the preferred embodiments involve a data-transmission capability between the portable handheld electronic device and a separate device, system, or network, there are additional advantages provided that can be exploited for further user benefits. For example, if the user is accessing an online checking account using a PDA to transmit a security code in accordance with one or more of the preferred embodiments, the same connection that facilitates transmission of the security code could be used to transmit, to the user's PDA, other data such as a current checking account statement as a replacement for a hard copy statement. Or, if the user is engaging in a point-of-sale transaction, the point-of-sale station connection could transmit to the user's portable handheld electronic device 'store coupons' to be stored for a future point-of-sale transaction.

As technology develops, manufacturers might provide additional portable handheld electronic devices that can be employed with the preferred embodiments in addition to mobile phones, PDAs, and portable music players. And again, as stated previously, the preferred embodiments can also be implemented by a device designed to be used primarily or exclusively for the purpose of storing security codes. There are offered many possibilities to software or hardware designers and engineers for adapting and formatting the preferred embodiments to specific purposes.

While the present invention has been described with respect to certain preferred embodiments only, other modifications and variations might be made without departing from the spirit and scope of the present invention as set forth in the following claims.

I claim:

1. A system for user authentication, comprising:
a portable handheld electronic device, the portable handheld electronic device having a computer memory;
the portable handheld electronic device further being capable of producing auditory output and/or visual output;
a true visual cue and/or a true auditory cue stored in the computer memory;
a password, access code, and/or Personal Identification Number stored in the computer memory;
the portable handheld electronic device capable of transmitting, when authorized, the password, access code, and/or Personal Identification Number;
authorization for transmitting the password, access code, and/or Personal Identification Number occurring only when the auditory output of the portable handheld electronic device is the true auditory cue and/or the visual output of the portable handheld electronic device is the true visual cue.

2. The system for user authentication of claim 1, further comprising a user identification string and/or user account information stored in the computer memory.
the portable handheld electronic device further being capable of transmitting the user identification string and/or user account information.

3. The system for user authentication of claim 1, wherein the transmission of the password, access code, and/or Personal Identification Number is by wireless transmission or by a hard wire connection.

4. The system for user authentication of claim 1, wherein the portable handheld electronic device is a mobile telephone, a personal music player, or a PDA.

5. The system for user authentication of claim 1, further comprising one or more false visual cues and/or one or more false auditory cues stored in the computer memory.

6. The system for user authentication of claim 1, further comprising one or more false passwords, access codes, or Personal Identification Numbers stored in the computer memory.

7. The system for user authentication of claim 1, wherein the password, access code, and/or Personal Identification Number is encrypted.

8. the system for user authentication of claim 1, wherein the portable handheld electronic device is designed to be used primarily or exclusively for the purpose of storing security codes

9. A method for user authentication, comprising:
receiving a true visual cue and/or a true auditory cue from a portable handheld electronic device;
initiating a transmit command when the true visual cue and/or the true auditory cue is/are received;
the transmit command resulting in the transmission of a password, access code, PIN, and/or other security code from the portable handheld electronic device.

10. The method for user authentication of claim 9, wherein the transmission of the password, access code, PIN, and/or other security code is to an ATM machine or point-of-sale station.

11. The method for user authentication of claim 9, wherein the transmission of the password, access code, PIN, and/or other security code is to a computer or network.

12. The method for user authentication of claim 9, wherein the transmission of the password, access code, PIN, and/or other security code is to a software program or file.

13. The method for user authentication of claim 9, wherein the transmission of the password, access code, PIN, and/or other security code is to a website.

14. The method for user authentication of claim 9, wherein the transmission of the password, access code, PIN, and/or other security code is to a device or lock controlling access to a facility.

15. The method for user authentication of claim 9, wherein the transmission of the password, access code, PIN, and/or other security code is encrypted.

16. A system for user authentication, wherein a user's password, access code, and/or PIN is stored in a portable handheld electronic device having computer memory;
also stored in the portable handheld electronic device having computer memory is a true visual cue and/or a true auditory cue;
the portable handheld electronic device having computer memory further including means to display the true visual cue and/or play the true auditory cue;
the portable handheld electronic device having computer memory further including means to transmit the user's password, access code, and/or PIN when transmission is authorized;
transmission being authorized only when true visual cue is displayed and/or the true auditory cue is played; and
transmission of the user's password, access code, and/or PIN resulting in an access granted session.

17. The system for user authentication of claim 16, wherein the user's password, access code, and/or PIN is changed to a new security code during the access granted session and the new security code is stored in the portable handheld electronic device having computer memory;
the new security code capable of resulting in a future access granted session.

18. The system for user authentication of claim 16, wherein a user identification string is included.

19. The system for user authentication of claim 16, wherein the user's password, access code, and/or PIN is encrypted.
